(19) United States
(12) Patent Application Publication
(10) Pub. No.: US 2016/0006997 A1
(43) Pub. Date: Jan. 7, 2016

(54) Video Projector Assembly

(71) Applicants: Tita L. Bouie, Salisbury, NC (US); Sherrod Jones, Salisbury, NC (US)

(72) Inventors: Tita L. Bouie, Salisbury, NC (US); Sherrod Jones, Salisbury, NC (US)

(21) Appl. No.: 14/323,613

(22) Filed: Jul. 3, 2014

(51) Int. Cl. H04N 9/31

(52) U.S. Cl. CPC H04N 9/3173

(57) ABSTRACT

A video projector assembly includes a housing that has a length and a width between about 12 cm and 15 cm. The housing may be carried by a user. A processor is coupled to the housing. A projector is coupled to the housing and the processor. The projector projects an image onto a surface. The image is visible to an observer. A data port is coupled to the housing and the processor. The data port is selectively operationally coupled to an external electronic device. The data port transfers data of the image to between the external electronic device and the processor. A display is coupled to the housing and the processor. A user touches the display to actuate the processor and the projector. An actuator is coupled to the housing and the processor. The user actuates the actuator to controls the processor and the projector.

### BACKGROUND OF THE DISCLOSURE

### Field of the Disclosure

The disclosure relates to projector devices and more particularly pertains to a new projector device for displaying an image on a surface.

### SUMMARY OF THE DISCLOSURE

An embodiment of the disclosure meets the needs presented above by generally comprising a housing that has a length and a width between about 12 cm and 15 cm. The housing may be carried by a user. A processor is coupled to the housing. A projector is coupled to the housing. The projector is operationally coupled to the processor. The projector projects an image onto a surface. The image is visible to an observer. A data port is coupled to the housing. The data port is operationally coupled to the processor. The data port is selectively operationally coupled to an external electronic device. The data port transfers data of the image to between the external electronic device and the processor. A display is coupled to the housing. The display is operationally coupled to the processor. A user touches the display to actuate the processor and the projector. An actuator is coupled to the housing. The actuator is operationally coupled to the processor. The user actuates the actuator to controls the processor and the projector.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a video projector assembly according to an embodiment of the disclosure.

FIG. 2 is a front view of an embodiment of the disclosure.

FIG. 3 is a front perspective view of an embodiment of the disclosure.

FIG. 4 is a left side view of an embodiment of the disclosure.

FIG. 5 is a top view of an embodiment of the disclosure.

FIG. 6 is a bottom view of an embodiment of the disclosure.

FIG. 7 is a schematic view of an embodiment of the disclosure.

### DESCRIPTION OF THE PREFERRED EMBODIMENT

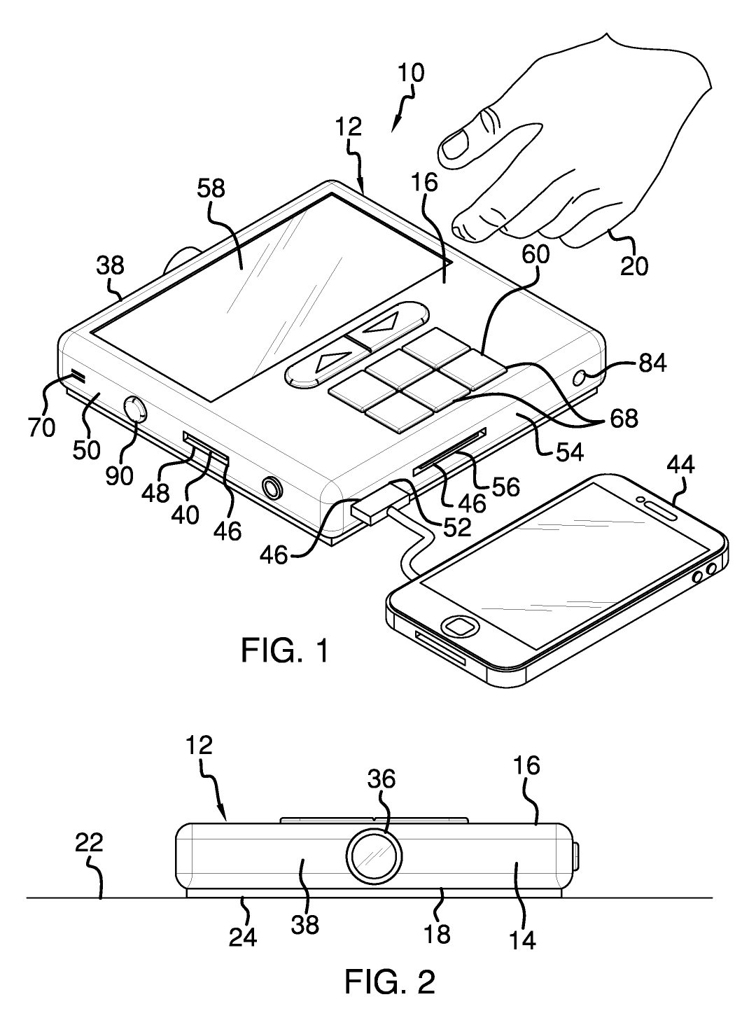

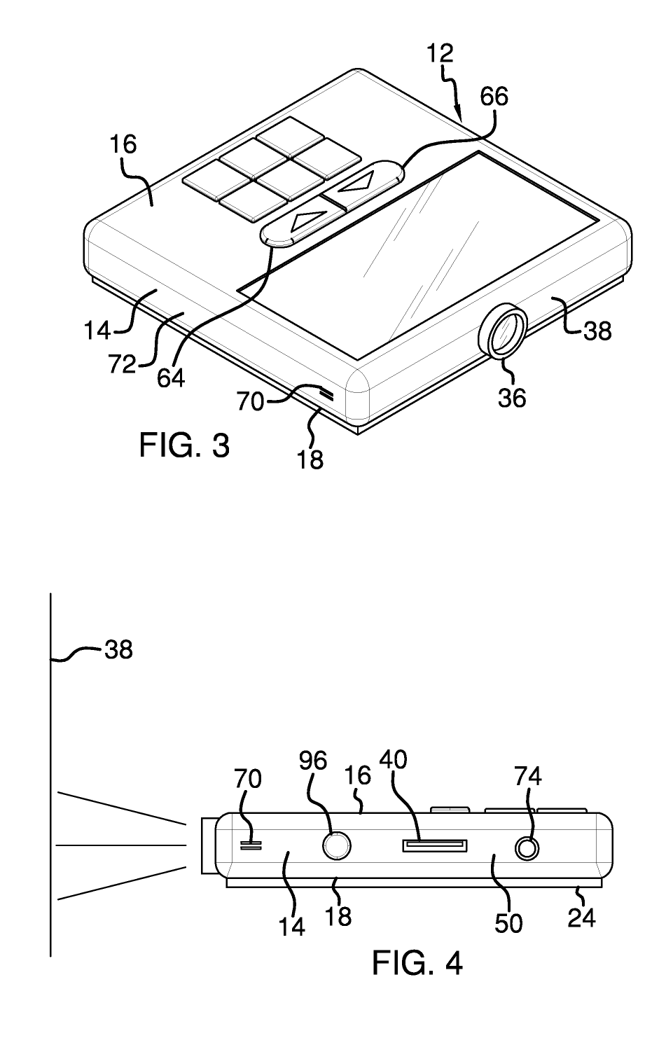

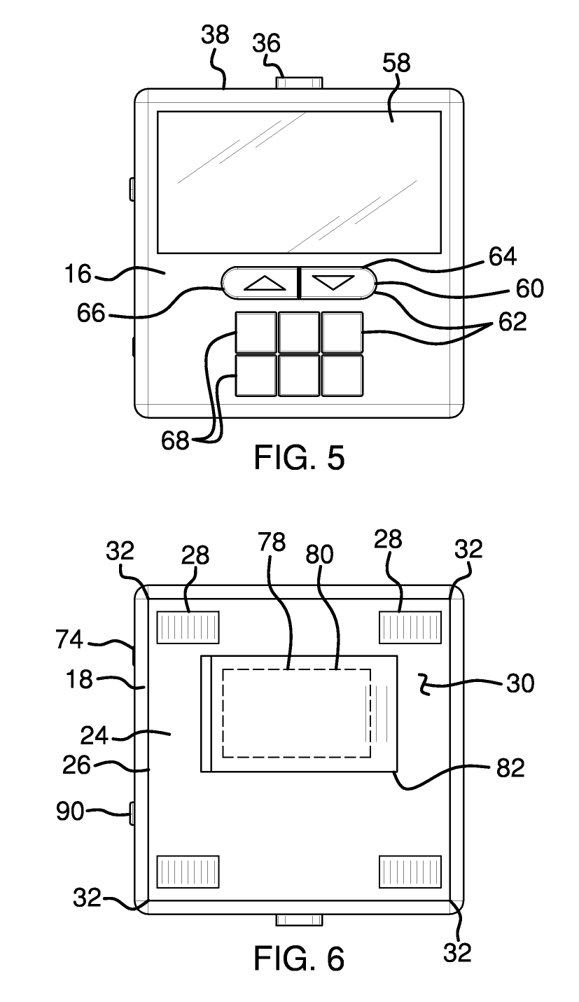

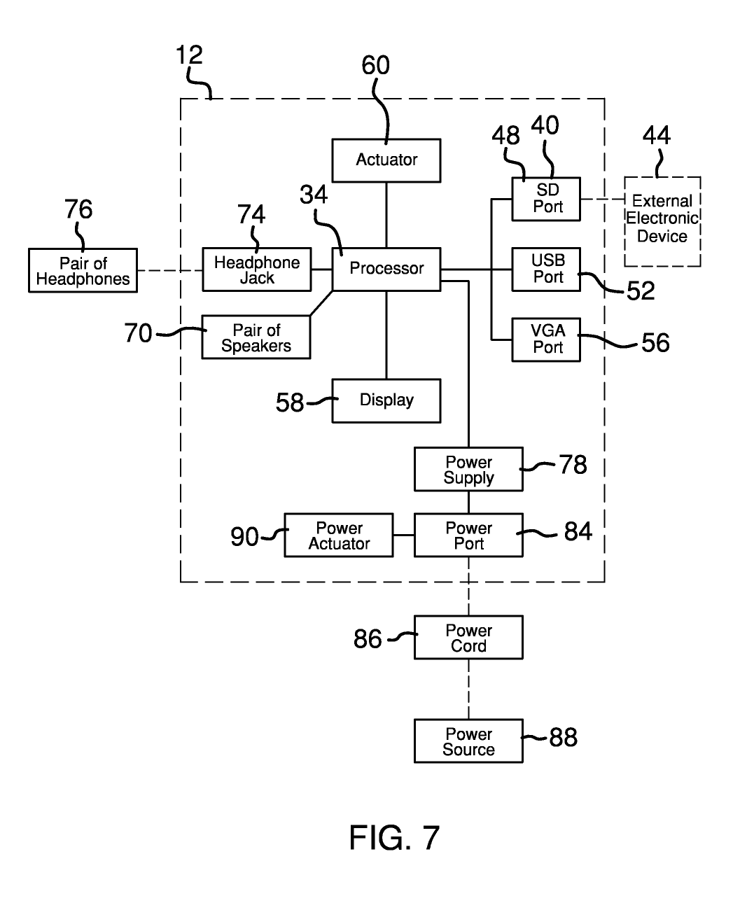

With reference now to the drawings, and in particular to FIGS. 1 through 7 thereof, a new projector device embodying the principles and concepts of an embodiment of the disclosure and generally designated by the reference numeral 10 will be described.

As best illustrated in FIGS. 1 through 7, the video projector assembly 10 generally comprises a housing 12 that has an exterior wall 14 extending between each of a top wall 16 and a bottom wall 18 of the housing 12. Each of the top 16 and bottom 18 walls of the housing 12 may have a length and a width between about 12 cm and 15 cm. Moreover, the housing 12 may be carried by a user 20. The housing 12 is positionable on a support surface 22. The support surface 22 may be a table top or other similar horizontal support surface.

A base 24 is coupled to and extends downwardly from the bottom wall 18 of the housing 12. An outer edge 26 of the base 24 is coextensive with the exterior wall 14 of the housing 12. A plurality of feet 28 are coupled to a lower surface 30 of the base 24. Each of the plurality of feet 28 are positioned proximate an associated one of four corners 32 of the base 24. The plurality of feet 28 each abuts the support surface 22. The plurality of feet 28 supports the housing 12 above the support surface 22.

A processor 34 is coupled to the housing 12. The processor 34 may be an electronic processor of any conventional design. A projector 36 is coupled to a front side 38 of the exterior wall 14 of the housing 12. The projector 36 is centrally positioned on the front side 38 of the exterior wall 14 of the housing 12.

The projector 36 is electrically coupled to the processor 34. Additionally, the projector 36 projects an image onto a vertical surface 38 so an image is visible to an observer. The vertical surface 38 may be a wall or other similar vertical surface. The projector 36 may be a an HD projector of any conventional design.

A data port 40 is coupled to the exterior wall 14 of the housing 12. The data port 40 is electrically coupled to the processor 36. The data port 40 insertably receives a data cord 42 so the data port 40 is electrically coupled to an external electronic device 44. The external electronic device 44 may be a personal computer of any conventional design. The data port 40 transfers data of the image to between the external electronic device 44 and the processor 36.

The data port 40 is one of a plurality of the data ports 46. An SD one 48 of the plurality of data ports 46 is positioned on a first lateral side 50 of the exterior wall 14 of the housing 12. The SD port 48 insertably receives an SD card of any conventional design. A USB one 52 of the plurality of data ports 46 is positioned on a back side 54 of the exterior wall 14 of the housing 12. The USB port 52 insertably receives a USB cable of any conventional design. A VGA one 56 of the plurality of data ports 46 is positioned on the back side 54 of the exterior wall 14 of the housing 12. The VGA port 56 insertably receives a VGA cable of any conventional design.

A display 58 is coupled to the top wall 16 of the housing 12. The display 58 is positioned proximate the front side 38 of the exterior wall 14 of the housing 12. The display 58 is electrically coupled to the processor 34. The user 20 touches the display 58 to actuate the processor 34 and the projector 36. Additionally, the user 20 selects which of the plurality of data ports 46 is to be utilized to transfer the image data. The display 58 may be a touch screen display of any conventional design.

An actuator 60 is coupled to the top wall 16 of the housing 12. The actuator 60 is electrically coupled to the processor 34. The actuator 60 is one of a plurality of the actuators 62. The plurality of actuators 62 is positioned between the display 58 and the back side 54 of the exterior wall 14 of the housing 12.

A zoom out one 64 of the plurality of actuators 62 zooms the projector 36 so the size of the projected image is reduced. A zoom in one 66 of the plurality of actuators 62 zooms the projector 36 so the size of the projected image is increased. The plurality of actuators 62 includes a set of action actuators 68. The set of action actuators 68 controls various functions of the projector 36 to include image type, file source, volume and other similar projector 36 functions.

A pair of speakers 70 is each coupled to an associated one of the first lateral side 50 and a second lateral side 72 of the exterior wall 14 of the housing 12. Each of the pair of speakers 70 is electrically coupled to the processor 36. The pair of speakers 70 each emits an audible sound. A headphone jack 74 is coupled to the first lateral side 50 of the exterior wall 14 of the housing 12. The headphone jack 74 is electrically coupled to the processor 34. The headphone jack 74 may be electrically coupled to a pair of headphones 76.

A power supply 78 is coupled to the housing 12. The power supply 78 is electrically coupled to the processor 34. The power supply 78 comprises at least one rechargeable battery 80. A battery cover 82 is removably coupled to the base 24 on the housing 12. The power supply 78 is positioned beneath the battery cover 82.

A power port 84 is coupled to the back side 54 of the exterior wall 14 of the housing 12. The power port 84 is electrically coupled to the power supply 78. The power port 84 insertably receives a power cord 86. The power cord 86 is electrically coupled to a power source 88. The power source 88 may be an electrical outlet of any conventional design. Finally, the power port 84 charges the power supply 78.

A power actuator 90 is coupled to the first lateral side 50 of the exterior wall 14 of the housing 12. The power actuator 90 is electrically coupled to the power supply 78. The power actuator 90 actuates and de-actuates the power supply 78.

In use, the housing 12 is positioned on the support surface 22 so the projector 36 is directed toward the vertical surface 38 on which the image is to be displayed. The external electronic device 44 is electrically coupled to a selected one of the plurality of data ports 46. The user 20 touches the display 58 to actuate the processor 34 and the projector 36. The user 20 additionally actuates a selected one of the plurality of actuators 62 to adjust a size of the projected image and other functional parameters of the assembly 10. The assembly 10 allows the user 20 to conduct a video presentation in any location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A video projector assembly for displaying an image on a surface, said assembly comprising:
a housing having a length and a width between about 12 cm and 15 cm wherein said housing is configured to be carried by a user;
a processor coupled to said housing;
a projector coupled to said housing, said projector being operationally coupled to said processor, said projector projecting the image onto the surface wherein the image is visible to an observer;
a data port coupled to said housing, said data port being operationally coupled to said processor, said data port being selectively operationally coupled to an external electronic device wherein said data port transfers data of the image to between the external electronic device and said processor;
a display coupled to said housing, said display being operationally coupled to said processor, a user touching said display wherein the user actuates said processor and said projector; and
an actuator coupled to said housing, said actuator being operationally coupled to said processor, the user actuating said actuator wherein the user controls said processor and said projector.

2. The assembly according to claim 1, further comprising said housing having an exterior wall extending between each of a top wall and a bottom wall of said housing.

3. The assembly according to claim 1, further comprising said projector being coupled to a front side of an exterior wall of said housing.

4. The assembly according to claim 1, further comprising said projector being electrically coupled to said processor.

5. The assembly according to claim 1, further comprising said data port being electrically coupled to said processor.

6. The assembly according to claim 1, further comprising said data port insertably receiving a data cord wherein said data port is electrically coupled to the external electronic device.

7. The assembly according to claim 1, further comprising said display being coupled to a top wall of said housing.

8. The assembly according to claim 1, further comprising said display being electrically coupled to said processor.

9. The assembly according to claim 1, further comprising said actuator being coupled to a top wall of said housing.

10. The assembly according to claim 1, further comprising said actuator being electrically coupled to said processor.

11. The assembly according to claim 1, further comprising a power supply coupled to said housing.

12. The assembly according to claim 11, further comprising said power supply being electrically coupled to said processor.

13. The assembly according to claim 1, further comprising said power supply comprising at least one battery.

14. The assembly according to claim 1, further comprising a power actuator coupled to an exterior wall of said housing, said power actuator being electrically coupled to a power supply such that said power actuator actuates said power supply.

15. A video projector assembly for displaying an image on a surface, said assembly comprising:
a housing having an exterior wall extending between each of a top wall and a bottom wall of said housing, each of said top and bottom walls of said housing having a length and a width between about 12 cm and 15 cm wherein said housing is configured to be carried by a user;
a processor coupled to said housing;
a projector coupled to a front side of said exterior wall of said housing, said projector being electrically coupled to said processor, said projector projecting the image onto the surface wherein the image is visible to an observer;
a data port coupled to said housing, said data port being electrically coupled to said processor, said data port insertably receiving a data cord wherein said data port is electrically coupled to an external electronic device, said data port transferring data of the image to between the external electronic device and said processor;
a display coupled to said top wall of said housing, said display being electrically coupled to said processor, a user touching said display wherein the user actuates said processor and said projector; and
an actuator coupled to said top wall of said housing, said actuator being electrically coupled to said processor, the user actuating said actuator wherein the user controls said processor and said projector;
a power supply coupled to said housing, said power supply being electrically coupled to said processor, said power supply comprising at least one battery; and
a power actuator coupled to said exterior wall of said housing, said power actuator being electrically coupled to said power supply such that said power actuator actuates said power supply.
